(19) United States
(12) Patent Application Publication
(10) Pub. No.: US 2026/0047913 A1
(43) Pub. Date: Feb. 19, 2026

(54) ONE-STEP DENTAL IMPLANT APPARATUS AND METHODS

(71) Applicant: Bernard Gantes, La Quinta, CA (US)

(72) Inventor: Bernard Gantes, La Quinta, CA (US)

(21) Appl. No.: 19/301,876

(22) Filed: Aug. 15, 2025

Related U.S. Application Data
(60) Provisional application No. 63/683,971, filed on Aug. 16, 2024.

(51) Int. Cl. A61C 8/00

(52) U.S. Cl. CPC A61C 8/0021

(57) ABSTRACT

An apparatus and methods are provided for a one-step dental implant that avoids pressure points and heat production within a patient's bone. The dental implant includes a bone cutting portion having a centering tip surrounded by bone cutting edges and soft tissue knives. The centering tip perforates the gingiva while the soft tissue knives dissect the gingiva with a precise circular cut. The bone cutting edges chisel the bone as the dental implant is tightened into the bone. Deflecting sides direct bone powder into axial bone storage areas. A gingival sealing portion includes a cylindrical portion that fits into cortical bone without friction or exerting pressure on the bone. The cylindrical portion removably retains components that include a silicone O-ring. Engaging sections of the cylindrical portion enable driving the dental implant into the patient's bone. Internal threads of the cylindrical portion enable clamping abutments onto the dental implant.

### PRIORITY

This application claims the benefit of and priority to U.S. Provisional Application, entitled “One-Step Dental Implant,” filed on Aug. 16, 2024, and having application Ser. No. 63/683,971, the entirety of said application being incorporated herein by reference.

### FIELD

Embodiments of the present disclosure generally relate to dental implants. More specifically, embodiments of the disclosure relate to a one-step dental implant apparatus and methods that overcome the difficulties encountered with traditional dental implants.

### BACKGROUND

Traditional dental implants require the use of sequential drilling (e.g., progressive diameters rotating between 500-2000 RPM) to create an implantation site in the bone. Traditional implants require external and internal (through the drill) water irrigation to reduce the heat production (in the range of 50° C. to 80° C.) from the drills which have a detrimental effect on the bone (bone injury occurs above 50° C.). Because of heat exposure to the bone, traditional implants require extended healing time (e.g., 9 to 17 additional weeks) to allow bone repair due the heat injury.

Freehanded pre-drilling can't create an implant bone bed (osteotomy) of the intended shape because drill movements carried by an arm/hand can only create a hybrid linear motion mixed with some level of rotation. To compensate for the resulting oversized osteotomy, traditional implants generally have a conical general shape that applies more pressure to the bone in an attempt to induce more bone remodeling and reduce healing delays.

Another drawback to traditional dental implants is that traditional surgical guides provide templates for pre-drilling and implant placement that are pre-determined during a digital treatment plan phase. Such a guided treatment does not allow any flexibility for the clinician during the surgery.

After implant placement, traditional implants require multiple engagement of temporary components in metal causing wear and tear on the connection and the female threads of the implant. Further, during prosthetic fabrication in the laboratory, traditional restorative components require multiple engagements on implant analogs that are made of steel, as well as constant exposure to abrasive powder and debris, thus causing wear and tear on the restorative interface.

For traditional implants, restorative screw connections are not reliable due to the engagements of parts out of manufacturer specification. For example, multiple sources report between 10% and 15% screw loosening within 5 years. As such, there is a continuing desire to develop a one-step dental implant apparatus and methods that overcome the above and other drawbacks to traditional dental implants.

### SUMMARY

An apparatus and methods are provided for a one-step dental implant that avoids pressure points and heat production within a patient's bone. The dental implant includes a bone cutting portion having a centering tip surrounded by bone cutting edges and soft tissue knives. The centering tip perforates the gingiva while the soft tissue knives dissect the gingiva with a precise circular cut. The bone cutting edges chisel the bone as the dental implant is tightened into the bone. Deflecting sides direct bone powder into axial bone storage areas. Bone thread cutters along the circular bone storage areas have a taping effect on the bone. A gingival sealing portion includes a cylindrical portion that fits into cortical bone without friction or exerting pressure on the bone. The cylindrical portion removably retains components that include a silicone O-ring. Engaging sections of the cylindrical portion enable driving the dental implant into the patient's bone. Internal threads of the cylindrical portion enable clamping abutments onto the dental implant.

In another exemplary embodiment, the soft tissue knives dissect the gingiva with a precise circular cut that has an internal diameter equal to a diameter of the dental implant within implant valleys between the threads comprising the bone cortex interface. In another exemplary embodiment, the soft tissue knives extend between about 0.2 mm and about 1.0 mm at the periphery to function as soft tissue dissector. In another exemplary embodiment, the soft tissue knives extend by about 0.5 mm at the periphery. In another exemplary embodiment, the implant valleys have a diameter that creates a gap of about 0.09 mm to assist the axial bone storage areas in harvesting bone powder. In another exemplary embodiment, the smaller diameter of the implant valleys is configured to create a gap ranging between about 0.05 mm and about 0.2 mm.

In another exemplary embodiment, the bone cutting edges are configured to chisel the bone as the dental implant is tightened into the bone. In another exemplary embodiment, the deflecting sides are configured to provide spaces that receive bone chips and bone powder that can be directed into the bone powder storage portion without producing heat in the surrounding bone. In another exemplary embodiment, each of the deflecting sides has a section angle of about 52 degrees in the center and an angle of about 105 degrees with respect to flutes comprising the bone powder storage portion. In another exemplary embodiment, the section angle ranges between about 45 degrees and about 65 degrees; and wherein the angle relative to the flutes ranges between about 95 degrees and about 115 degrees.

In another exemplary embodiment, the three bone cutting edges meet at the center tip with any one or more of a point angle of about 67 degrees, a point length of about 0.9 mm, and a rake angle of about 77 degrees. In another exemplary embodiment, the point angle can range between about 50 degrees and about 80 degrees; In another exemplary embodiment, the point length can range between about 0.4 mm and about 1.5 mm; and wherein the rake angle can range between about 60 degrees and about 85 degrees.

In another exemplary embodiment, the centering tip perforates the gingiva, contacts the bone, and then fixates a longitudinal axis of the dental implant within the bone. In another exemplary embodiment, the centering tip is centered on the longitudinal axis of the dental implant and extends 0.75 mm beyond the body of the dental implant. In another exemplary embodiment, the centering tip extends beyond the body of the dental implant by a distance ranging between roughly 0.2 mm and about 1.5 mm. In another exemplary embodiment, the bone cutting edges have a cutting angle of about 57 degrees with respect to the longitudinal axis. In another exemplary embodiment, the deflecting sides have a deflecting angle of about 40 degrees relative to the longitudinal axis. In another exemplary embodiment, the cutting angle ranges between about 40 degrees and about 75 degrees, and the deflecting angle ranges between about 30 degrees and about 50 degrees.

In another exemplary embodiment, axial bone storage areas each has a pitch of about 50 mm and a width of about 2.25 mm with a depth of about 0.9 mm. In another exemplary embodiment, the pitch ranges between about 30 mm and about 70 mm; In another exemplary embodiment, the width ranges between about 1.5 mm and about 3.5 mm; and wherein the depth ranges between about 0.5 mm and about 1.5 mm. In another exemplary embodiment, axial bone storage areas each has a length ranging between about 5 mm and about 8 mm. In another exemplary embodiment, the axial bone storage areas each has a length of about 6 mm.

In another exemplary embodiment, the bone thread cutter has an angle of 60 degrees with respect to a wall of the axial bone storage area. In another exemplary embodiment, the angle of the bone thread cutter ranges between about 50 degrees and about 85 degrees. In another exemplary embodiment, the bone thread cutter has a progressively changing profile from a truncated triangle-shape to a full triangle-shape from the entry of the axial bone storage area to the end of the axial bone storage area.

In another exemplary embodiment, the threads comprising the bone cortex interface have a 0.5 mm thread pitch with a thread profile of about 48 degrees included angle. In another exemplary embodiment, the thread pitch ranges between about 0.3 mm and about 0.7 mm, and the thread profile ranges between about 40 degrees and about 55 degrees of included angle. In another exemplary embodiment, the bone cortex interface ranges in height between about 2.5 mm and about 4.5 mm to accommodate implant lengths between about 9 mm and about 13 mm for the 3.5 mm and 4.5 mm diameter implants. In another exemplary embodiment, the bone cortex interface ranges in height between about 1.5 mm and about 5 mm to accommodate implant lengths between about 7 mm and about 11 mm for a 5.5 mm diameter implant.

In another exemplary embodiment, the cylindrical portion comprises a conical connection that is dedicated to titanium abutments. In another exemplary embodiment, the cylindrical portion includes an occlusal third surface comprising a polished metal surface that measures about 0.9 mm. In another exemplary embodiment, the conical connection includes a conical slope comprising a cervical section and an apical section.

In another exemplary embodiment, conical slope comprises an angle of about 29 degrees. In another exemplary embodiment, angle comprising the conical slope ranges between about 25 degrees and 35 degrees.

In another exemplary embodiment, the cylindrical portion comprises: a retention groove that removably retains components that include a silicone O-ring; one or more engaging sections comprising apical extensions of the cylindrical portion; a flange to provide a stop for temporary components and full zirconia abutments; and internal threads to enable clamping abutments onto the cylindrical portion. In another exemplary embodiment, the engaging sections enable driving the dental implant into the patient's bone and to prevent rotation of abutments when needed. In another exemplary embodiment, the one or more engaging sections comprises between two and five engaging sections. In another exemplary embodiment, the one or more engaging sections includes three engaging sections. In another exemplary embodiment, the internal threads are M2-sized threads disposed on an inner surface of a 4.5 mm diameter hole.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates a side view of an exemplary embodiment of a one-step dental implant configured to avoid pressure points and heat production within a patient's bone;

FIG. 2 is a lower perspective view showing bone cutting edges and soft tissue knives comprising the dental implant of FIG. 1;

FIG. 3 is an upper perspective view showing a cylindrical portion and engaging sections of the dental implant of FIG. 1;

FIG. 4 illustrates an exemplary embodiment of a profile of a bone cutting portion that can be implemented in the dental implant of FIGS. 1-3;

FIG. 5 illustrates an exemplary embodiment of an implant carrier configured to engage with the dental implant shown in FIGS. 1-3;

FIG. 6 illustrates an exemplary embodiment of a set of gingival healing temporary components configured to engage with the dental implant of FIGS. 1-3;

FIG. 7 illustrates an exemplary embodiment of a position recording coping and an exemplary embodiment of a gingival sculpturing shape;

FIG. 8 illustrates the gingival sculpturing shape mounted onto the position recording coping of FIG. 7;

FIG. 9 illustrates an exemplary embodiment of a titanium protective cap configured to prevent contact or dust exposure of an abutment interface during prosthetic fabrication;

FIG. 10 illustrates an exemplary embodiment of a laboratory transfer coping;

FIG. 11A illustrates an exemplary embodiment of an abutment interface with and without an exemplary embodiment of a titanium protective cap installed;

FIG. 11B illustrates an exemplary embodiment of a titanium protective cap with and without O-rings installed;

FIG. 12 illustrates an exemplary embodiment of several engaging and non-engaging connections that may be used to connect with the dental implant of FIGS. 1-3;

FIG. 13A illustrates an exemplary embodiment of a titanium cylinders with an exposed implant connection on one end of the cylinder;

FIG. 13B illustrates an exemplary embodiment of a titanium cylinders with an exemplary embodiment of a protective cap placed onto an implant connection;

FIG. 14A illustrates an exemplary embodiment of a titanium base and an exemplary embodiment of a protective cap for protecting an engaging end of the titanium base during fabrication of an abutment and prosthesis;

FIG. 14B illustrates an exemplary embodiment of an abutment printed onto a titanium base while an engaging end of the titanium base is protected by a protective cap;

FIG. 15 illustrates an exemplary embodiment of a titanium base and an exemplary embodiment of a protective cap for protecting an engaging end of the titanium base during milling a zirconia prosthesis;

FIG. 16 illustrates an exemplary embodiment of a fully milled zirconia abutment that is clamped to a titanium by way of a screw;

FIG. 17 illustrates an exemplary embodiment of a hand driver for preventing dropping small implant components in the airways of a patient;

FIG. 18 illustrates an exemplary embodiment of a disposable torque controller configured to be coupled with the hand driver of FIG. 17;

FIG. 19 illustrates an exemplary embodiment of a stackable surgical guide and an implant carrier for achieving maximal precision in positioning of the dental implant of FIGS. 1-3; and

FIG. 20 illustrates an exemplary embodiment of a stackable surgical guide being used to direct the orientation of a dental implant coupled with an implant carrier.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the apparatus and methods disclosed herein may be practiced without these specific details. In other instances, specific numeric references such as “first implant,” may be made. However, the specific numeric reference should not be interpreted as a literal sequential order but rather interpreted that the “first implant” is different than a “second implant.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Traditional dental implants require sequential drilling to create an implantation site in the bone, and the resulting heat from the drills cause bone injuries that require extended healing times. Freehanded pre-drilling can't create an osteotomy of the intended shape, thus requiring conical shaped implants that apply more pressure to the bone to induce more bone remodeling and reduce healing delays. After implant placement, traditional implants require multiple engagement of temporary components in metal causing wear and tear on the connection and the female threads of the implant. Further, restorative screw connections are not reliable due to the engagements of parts out of manufacturer specification. Embodiments presented herein provide a one-step dental implant apparatus and methods that overcome these and other drawbacks associated with traditional dental implants.

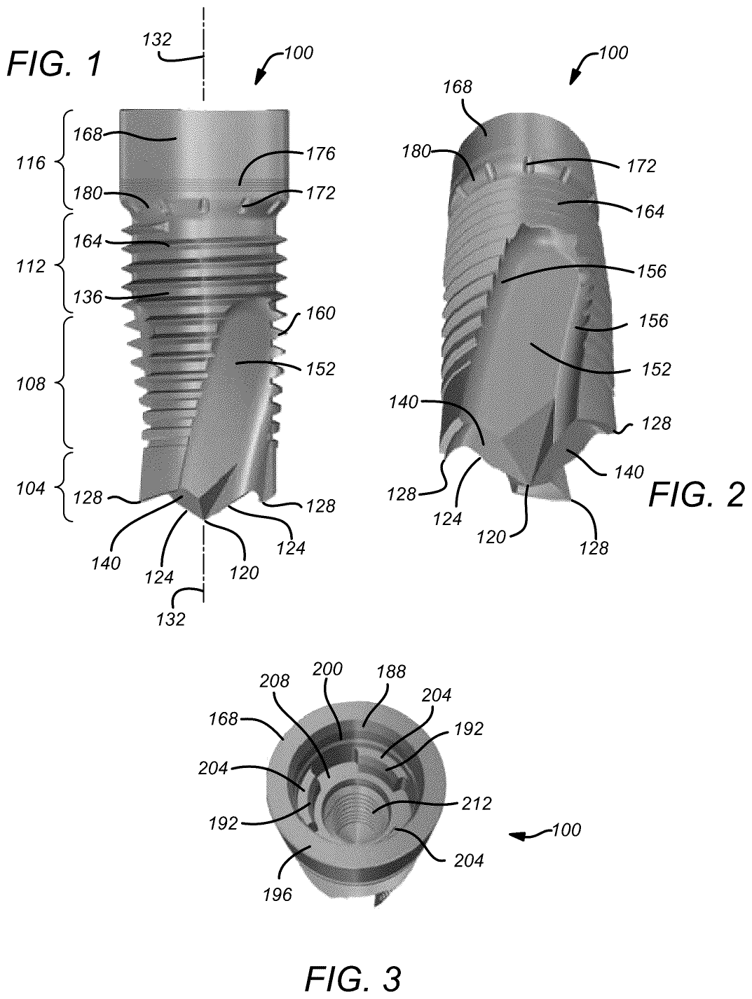

FIGS. 1-3 illustrate an exemplary embodiment of a one-step dental implant 100 (hereinafter, “dental implant 100”) that is configured to avoid pressure points and heat production within a patient's bone. The dental implant 100 has a generally cylindrical shape comprising a bone cutting portion 104, a bone powder storage portion 108, a bone cortex interface 112, and a gingival sealing portion 116. The embodiment of the dental implant 100 illustrated in FIGS. 1-3 comprises a medium-diameter implant having a diameter of about 4.5 mm and a length of about 11 mm. A narrow-diameter embodiment of the dental implant 100 can have a diameter of about 3.5 mm and a length of about 9 mm, while a wide-diameter embodiment of the dental implant 100 can have a diameter of about 5.5 mm and a length of about 13 mm. It should be borne in mind that while the narrow-, medium-, and wide-diameter dental implants 100 have different diameters and lengths, the implants will have similar features in angles and proportionate linear measurements.

As best shown in FIG. 2, the bone cutting portion 104 includes a centering tip 120 surrounded by bone cutting edges 124 and soft tissue knives 128. The centering tip 120 is configured to perforate the gingiva, contact the bone, and then fixate the longitudinal axis 132 of the dental implant 100 within the bone. The soft tissue knives 128 dissect the gingiva with a precise circular cut that has an internal diameter equal to the diameter of the dental implant 100 within implant valleys 136 comprising the bone cortex interface 112, as best shown in FIG. 1. The soft tissue knives 128 can extend between about 0.2 mm and about 1.0 mm at the periphery to function as soft tissue dissector. In the illustrated embodiment, the soft tissue knives 128 are extended by about 0.5 mm. It is contemplated that the soft tissue knives 128 operate similarly to the action of a soft tissue punch. Donut shaped soft tissue is eliminated sideways when the soft tissue knives 128 reach the bone surface. Further, the soft tissue knives 128 contribute to creating a bone bed that increases implant stability under non-axial loads.

The bone cutting edges 124 are each followed by a deflecting side 140. The bone cutting edges 124 are configured to chisel the bone as the dental implant 100 is tightened into the bone. The deflecting sides 140 are configured to provide spaces that receive bone chips and bone powder that can be directed into the bone powder storage portion 108 without producing heat in the surrounding bone. The deflecting sides 140 each has a section angle of about 52 degrees in the center and an angle of about 105 degrees with respect to flutes comprising the bone powder storage portion 108. The section angle can range between about 45 degrees and about 65 degrees, in some embodiments, while the angle relative to the flutes can range between about 95 degrees and about 115 degrees. In the illustrated embodiment, the dental implant 100 includes three pairs of bone cutting edges 124 and deflecting sides 140. In some embodiments, however, the dental implant 100 can include between two pairs and four pairs of bone cutting edges 124 and deflecting sides 140.

In the illustrated embodiment, the three bone cutting edges 124 meet at the center tip 120 with a point angle of about 67 degrees, a point length of about 0.9 mm, and a rake angle of about 77 degrees. In some embodiments, however, the point angle can range between about 50 degrees and about 80 degrees, the point length can range between about 0.4 mm and about 1.5 mm, and the rake angle can range between about 60 degrees and about 85 degrees.

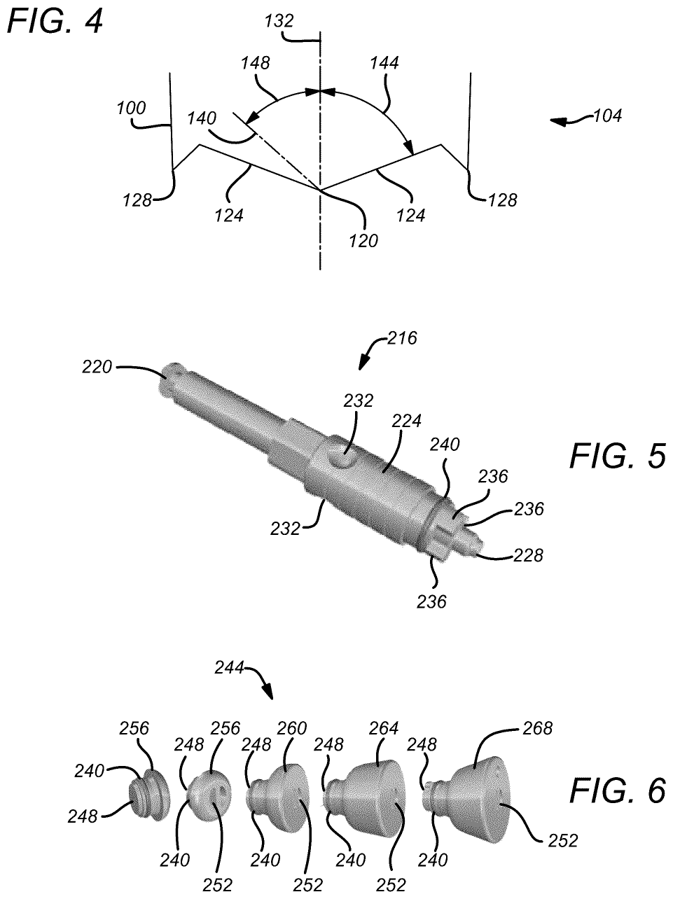

FIG. 4 illustrates an exemplary embodiment of a profile of a bone cutting portion 104 that can be implemented in the dental implant 100 of FIGS. 1-3. As shown, the centering tip 120 is centered on the longitudinal axis 132 of the dental implant 100. In the illustrated embodiment, the centering tip 120 extends 0.75 mm beyond the body of the dental implant 100. In some embodiments, the centering tip 120 extends beyond the body of the dental implant 100 by a distance ranging between roughly 0.2 mm and about 1.5 mm. Further, the bone cutting edges 124 have a cutting angle 144 of about 57 degrees with respect to the longitudinal axis 132, while the deflecting sides 140 have a deflecting angle 148 of about 40 degrees relative to the longitudinal axis 132. In some embodiments, the cutting angle 144 ranges between about 40 degrees and about 75 degrees, and the deflecting angle ranges between about 30 degrees and about 50 degrees. As described herein, the centering tip 120 allows first contact with the gingiva for flapless surgery followed by bone contact or directly with bone for flapped surgeries. The centering tip 120 prevents lateral movement of the dental implant 100 during implantation into the patient's bone.

Turning, again, to FIGS. 1-2, the bone powder storage portion 108 includes three axial bone storage areas 152, each disposed between circular bone storage areas 156, and bone thread cutters 160. The axial bone storage areas 152 are configured for storing vital bone powder. The axial bone storage areas 152 each has a pitch of about 50 mm and a width of about 2.25 mm with a depth of about 0.9 mm. In some embodiments, the pitch ranges between about 30 mm and about 70 mm, the width ranges between about 1.5 mm and about 3.5 mm, and the depth ranges between about 0.5 mm and about 1.5 mm. In the illustrated embodiment, the axial bone storage areas have a length of about 6 mm. In some embodiments, however, the length ranges between about 5 mm and about 8 mm.

The bone thread cutters 160 are disposed along the trailing edges of the circular bone storage areas 156 and are configured to have a taping effect on the bone. In the illustrated embodiment of FIGS. 1-3, the bone thread cutters 160 have an angle of 60 degrees with respect to the wall of the axial bone storage areas 152. In some embodiments, however, the angle of the bone thread cutters 160 ranges between about 50 degrees and about 85 degrees. As best shown in FIG. 1, the bone thread cutters 160 have a progressively changing profile from a truncated triangle-shape to a full triangle-shape from the entry of the axial bone storage areas 152 to the end of the axial bone storage areas 152.

As disclosed hereinabove, the soft tissue knives 128 dissect the gingiva with a precise circular cut that has an internal diameter equal to the diameter of the dental implant 100 within implant valleys 136 comprising the bone cortex interface 112, as best shown in FIG. 1. In the bone powder storage portion 108, however, the implant valleys 136 have a smaller diameter that creates a gap of about 0.09 mm to assist the axial bone storage areas 152 in harvesting bone powder. In some embodiments, the smaller diameter of the implant valleys 136 may be configured to create a gap ranging between about 0.05 mm and about 0.2 mm.

In the bone cortex interface 112, threads 164 extend around the circumference of the dental implant 100. The threads 164 are configured to engage with the bone and thus stabilize the dental implant 100. In the embodiment illustrated in FIG. 1, the threads 164 have a 0.5 mm thread pitch with a thread profile of about 48 degrees of included angle. In some embodiments, the thread pitch ranges between about 0.3 mm and about 0.7 mm, and the thread profile ranges between about 40 degrees and about 55 degrees of included angle. Further, the bone cortex interface 112 may range in height between about 2.5 mm and about 4.5 mm to accommodate implant lengths between about 9 mm and about 13 mm for the 3.5 mm and 4.5 mm diameter implants. In some embodiments, the bone cortex interface 112 may range in height between about 1.5 mm and about 5 mm to accommodate implant lengths between about 7 mm and about 11 mm for the 5.5 mm diameter implant.

With continuing reference to FIGS. 1-3, the gingival sealing portion 116 comprises a cylindrical portion 168 configured for fitting into cortical bone without friction or exerting pressure on the bone. The cylindrical portion 168 includes countersink reamers 172 and microgrooves 176. The countersink reamers 172 are arranged substantially uniformly around the circumference of a neck portion 180 of the cylindrical portion 168. The countersink reamers 172 are configured for precisely carving the bone for a precision fit of the neck portion 180 in the bone. The microgrooves 176 extend around the circumference of the neck portion 180 above the countersink reamers 172. The microgrooves 176 are configured to provide support for rapid bone regrowth. In the illustrated embodiment, five microgrooves 175 are incorporated into the cylindrical portion 168, although the dental implant 100 may include any number of microgrooves 175, without limitation. Further, the dental implant 100 can include a surface texture surface 184 that encourages bone regrowth. The surface texture can be created by acid washing, titanium particles blasting, or a combination thereof.

Turning, again, to FIG. 3, the cylindrical portion 168 is dedicated to temporary components and zirconia abutments. More specifically, the cylindrical portion 168 comprises a conical connection that is dedicated to titanium abutments. The conical connection includes a conical slope that is divided into sections: a cervical section 188 and an apical section 192. The angle of the conical slope is about 29 degrees, although the conical slope can range between about 25 degrees and 35 degrees in some embodiments. It is contemplated that male and female cones should connect at once on the entire cone area comprising the cervical section 188 and the apical section 192. Short of total contact area, an initial contact in the cervical section 188 has a stabilizing effect when it is firmly attached. Further, the cylindrical portion 168 includes an occlusal third surface 196 comprising a polished metal surface. In some embodiments, the occlusal third surface 196 measures about 0.9 mm.

With continuing reference to FIG. 3, the cylindrical portion 168 includes a retention groove 200, engaging sections 204, a flange 208, and internal threads 212. The retention groove 200 is disposed in the middle of the cylindrical portion 168 and is configured to allow retention of temporary components that include a silicone O-ring, such as, by way of example, a carrier, or PEEK temporary components. The O-ring can be anchored to the temporary component, compressed against the inside of the cylindrical portion 168, and then moved into the retention groove 200. It is contemplated that when the O-ring snaps into the retention groove 200, tactile feedback is provided to the clinician. It is further contemplated that axial pulling action will disengage the temporary component from the dental implant 100.

In the illustrated embodiment of FIG. 3, the cylindrical portion 168 includes three engaging sections 204, comprising apical extensions of the cylindrical portion 168. In some embodiments, however, the cylindrical portion 168 can include between two and five engaging sections 204. The engaging sections 204 are used to drive the dental implant 100 into the patient's bone and to prevent rotation of abutments when needed. Further, the flange 208 comprises a 90-degree surface configured to provide a stop for temporary components and full zirconia abutments. The internal threads 212 are configured to enable clamping abutments to the dental implant 100. In embodiments of the dental implant 100 having a 4.5 mm inner diameter, the internal threads 212 can be M2-sized threads.

Laboratory testing has demonstrated that the dental implant 100 exhibits certain features that are capable of changing the nature of dental implant treatments, due to accelerated healing, exceptional stability, and new technological developments described below. For example, the dental implant 100 can self-insert itself in all types of bone hardness without any need for pre-drilling. The dental implant 100 can be inserted by hand or with guided surgery at a speed of between about 10 RPM and about 25 RPM without water irrigation, opening precisely the gum and keeping the bone at body temperature. More specifically, a dental implant 100 having a length of 9 mm can be completely inserted into heathy bone in as little as about 15 rotations. An 11-mm dental implant 100 can be completely implanted into healthy bone in about 20 rotations while a 13-mm dental implant 100 needs only about 25 rotations for complete insertion into healthy bone. This feature allows an accelerated healing (i.e., integration of the dental implant 100 to the bone) in as little as 3 weeks, based on healthy bone healing studies.

Moreover, thread pitch of the dental implant 100 can be adjusted with respect to the tip cutting angle so as to control the vertical linear movement of the dental implant 100. This feature prevents heat production due to friction and prevents bone thread fractures. Further, the bone cutting portion 104 of the dental implant 100 is configured to carve in the bone a tip bed with a peripheral chamfer edge, which provides a superior lateral stability of the dental implant 100 under axial and non-axial loads.

FIG. 5 illustrates an exemplary embodiment of an implant carrier 216 configured to engage with the dental implant 100 shown in FIGS. 1-3. The implant carrier 216 can be made of stainless steel and can be mounted in a standard mechanical dental contra-angle handpiece or a hand driver. The implant carrier 216 comprises three portions: a connector 220 for engaging with the hand piece, a shaft 224, and an engaging end 228. The shaft 224 can vary in length to accommodate clinical situations (e.g., long, medium, and short implant carriers). In the illustrated embodiment, the short version of the implant carrier 216 is shown. In some embodiments, the shaft 224 has millimeter markings to provide guidance to the clinician on the sub-gingiva location of the implant neck.

As shown in FIG. 5, the shaft 224 includes three holes 232. The holes 232 align with the positions of engaging portions 236 comprising the engaging end 228. The engaging portions 236 are configured to fit between the engaging sections 204 of the dental implant 100. The engaging portions 236 are configured to contact the engaging sections 204 on a plane that is at a 90-degree angle with the tangent of the cylindrical portion 168 so as to prevent deformation of the dental implant 100 during the implantation process. The holes 232 enable the clinician to orient one of the engaging portions 236 in a facial direction for fitting of gingival molds.

When the implant carrier 216 is connected to the dental implant 100, the engaging end 228 does not touch the abovementioned conical portion of the cylindrical portion 168. Rather, the engaging tip 228 centers the implant carrier 216 into the implant threads 212. An O-ring 240 disposed on the engaging tip 228 is configured to assure proper positioning of the implant carrier 216 into the dental implant 100 and prevents any implant drop between the implant package and the implantation site. Disengagement can be achieved by pulling the implant carrier 216 away from the dental implant 100.

FIG. 6 illustrates an exemplary embodiment of a set of gingival healing temporary components 244. The gingival components 244 preferably are made of biocompatible PEEK polymer to prevent wear and tear to the dental implant 100. The gingival components 244 includes an engaging end 248 configured to engage with the cylindrical portion 168 of the dental implant 100. The engaging ends 248 all include an O-ring 240 for retention purposes. The gingival components 244 are configured to be inserted and removed by a push-pull action with a standard dental cotton roll plier. The gingival components 244 each includes a pair of cavities 252 that enable the gingival component 244 to be grabbed with the cotton roll plier. As will be appreciated, the gingival components 244 can be implemented with different shapes according to the clinical requirement. For example, in the illustrated embodiment, the gingival components 244 include an implant cover plug 256; a 3-mm high circular gingival plug 260, a 5-mm high circular gingival plug 264, and a 5-mm high oval gingival plug 268 for cuspid and maxillary bicuspids gingival molding. It is contemplated that other shapes will be available to meet different emergence profiles from different teeth.

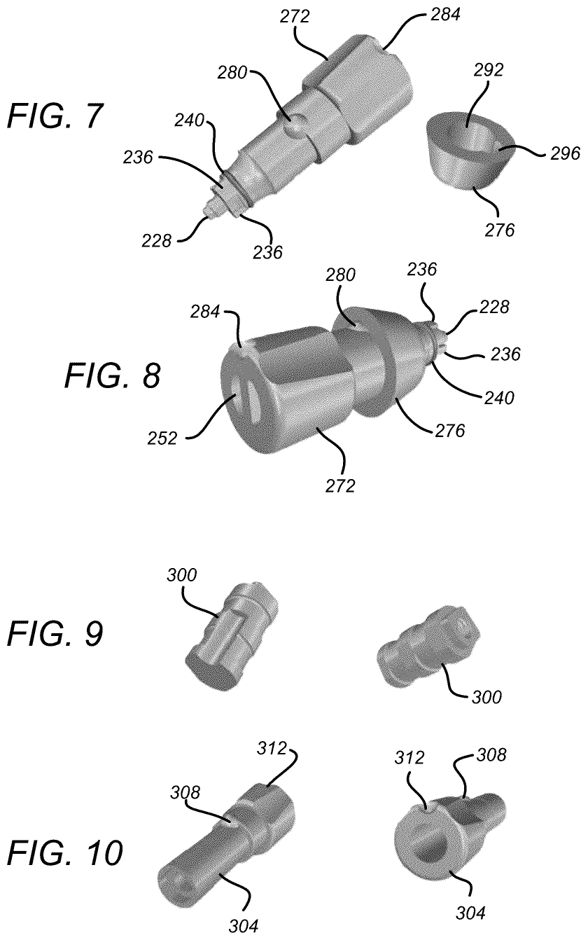

FIGS. 7-8 illustrate an exemplary embodiment of a position recording coping 272 and a gingival sculpturing shape 276. The position recording coping 272 and the gingival sculpturing shape 276 are made out of biocompatible PEEK polymer in order to prevent wear and tear to the dental implant 100. The position recording coping 272 includes an engaging end 228 configured to engage with the cylindrical portion 168 of the dental implant 100. The engaging end 228 includes an O-ring 240 for retention purposes. The position recording coping 272 is configured to be inserted and removed by a push-pull action with a standard dental cotton roll plier. As shown in FIG. 8, the position recording coping 272 includes a pair of cavities 252 that enable the position recording coping 272 to be grabbed with the cotton roll plier.

As shown in FIGS. 7-8, the position recording coping 272 includes an index 280 and an index notch 284. The index 280 and the index notch 284 align with the position of an engaging portion 236 comprising the engaging end 228. As mentioned above, in connection with the implant carrier 216, the engaging portions 236 are configured to fit between the engaging sections 204 of the dental implant 100. The index 280 and the index 284 enable the clinician to orient one of the engaging portions 236 in a facial direction for digital recording of implant position. An O-ring 240 disposed on the engaging tip 228 is configured to assure proper positioning of the position recording coping 272 into the dental implant 100. Disengagement can be achieved by pulling the position recording coping 272 away from the dental implant 100.

The gingival sculpturing shape 276 is a generally conical ring-shaped member having a central hole 292 and an index notch 296. As shown in FIG. 8, the gingival sculpturing shape 276 can be mounted onto the position recording coping 272. In the illustrated embodiment, the position recording coping 272 fits inside the central hole 292 with the index 280 engaged with the index notch 296. The position recording coping 272 and the gingival sculpturing shape 276 can be used for digital recording of implant position as well as for closed tray impression using dental elastomers for impression. In the last case scenario, the copings are embedded in the impression material.

FIG. 9 illustrates an exemplary embodiment of a titanium protective cap 300 configured to prevent contact or dust exposure of an abutment interface during prosthetic fabrication. The abutment system can be delivered with the titanium protective cap 300 installed. The titanium protective cap 300 can be removed prior to insertion into the dental implant 100 assuring, along with a new screw, the connection of a brand-new implant-abutment interface with an ideal torque. The laboratory platform connects to the abutment protected by the titanium protective cap 300 with a screw joint. The platform is indexed to reproduce the orientation of the dental implant 100. The platform can be an inserted and glued cavity of a 3D printed cast for digital applications. The platform can be incorporated into a stone cast for analog dentistry, as well. In some embodiments, the center position of the platform neck is 4.5 mm away from the center position of the neck of the dental implant 100 along the longitudinal axis 132 (see FIG. 1). In some embodiments, the center position of the platform neck is between about 2 mm and about 8 mm away from the center position of the neck of the dental implant 100 along the longitudinal axis 132.

FIG. 10 illustrates an exemplary embodiment of a laboratory transfer coping 304. The laboratory transfer coping 304 is configured to enable placing the laboratory platform in a stone cast for analog dentistry. The laboratory transfer coping 304 replaces the impression coping into an elastomer patient impression during the process. The laboratory platform can be attached to the laboratory transfer coping 304 by way of a laboratory steel screw. The laboratory transfer coping 304 includes an index 308 and an index notch 312. The index 308 and the index notch 312 facilitate reproducing the orientation of the dental implant 100.

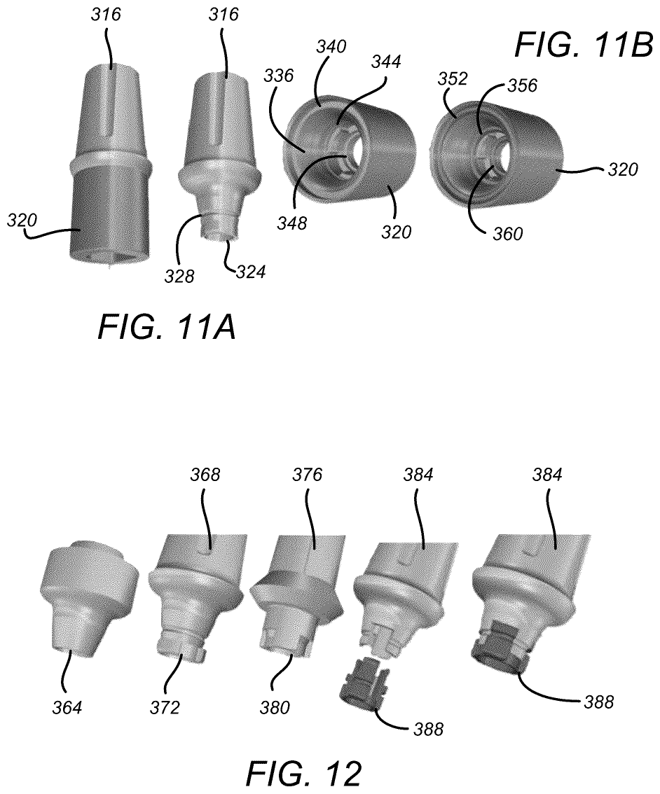

FIGS. 11A-11B illustrate an exemplary embodiment of an abutment interface 316 and a titanium protector 320. FIG. 11A illustrates the abutment interface 316 with and without the titanium protector 320 installed. The abutment interface 316 includes an engaging end 324 that has a groove 328. The groove 328 is configured to receive an O-ring 332 disposed inside the titanium protector 320. FIG. 11B illustrates the titanium protector 320 with and without O-rings installed. The titanium protector 320 is a generally cylindrical member having a central opening 336 configured to retain the engaging end 324 of the abutment interface 316. As such, the central opening 336 includes an outer groove 340, a middle groove 344, and an inner groove 348. As further shown in FIG. 11B, the outer groove 340 receives an outer O-ring 352, the middle groove 344 retains a middle O-ring 356, and the inner groove 348 retains an inner O-ring 360. The middle O-ring 336 is configured to be received into the groove 328 so as to retain the engaging end 324 within the central opening 336. The outer and inner O-rings 352, 360 are configured to have a slight compression on the abutment interface 316 to prevent dust penetration. As will be appreciated, the assembly of the abutment interface 316 and the titanium protector 320 is configured to be fastened to the laboratory platform with a laboratory steel screw.

FIG. 12 illustrates an exemplary embodiment of several engaging and non-engaging connections that may be used to connect with the dental implant 100 described hereinabove. More specifically, a non-engaging connection 364 may be used when abutment indexing is not relevant. Such an abutment is normally engaged in the dental implant 100 once and does not require a protecting cap. Next, is an engaging component 368 that includes an engaging end 372. The engaging end 372 is configured to engage the cylindrical portion 168 of the dental implant 100. As such, the engaging component 368 is delivered to the lab with a protective cap 320 (see FIGS. 11A-11B). Next, an engaging temporary component 376 is configured for provisional prosthesis and may be made of PEEK polymer. The engaging temporary component 376 includes an engaging end 380 that only engages the implant flange and the cylindrical portion 168 of the dental implant 100, thus leaving the conical connection untouched. Further, an optional engaging component 384 includes a removable titanium engaging portion 388. The optional engaging component 384 enables engagement or not by allowing a practitioner to install or remove the titanium engaging portion 388. As will be appreciated, the optional engaging component 384 is delivered to the lab with a protective cap 320 (see FIGS. 11A-11B).

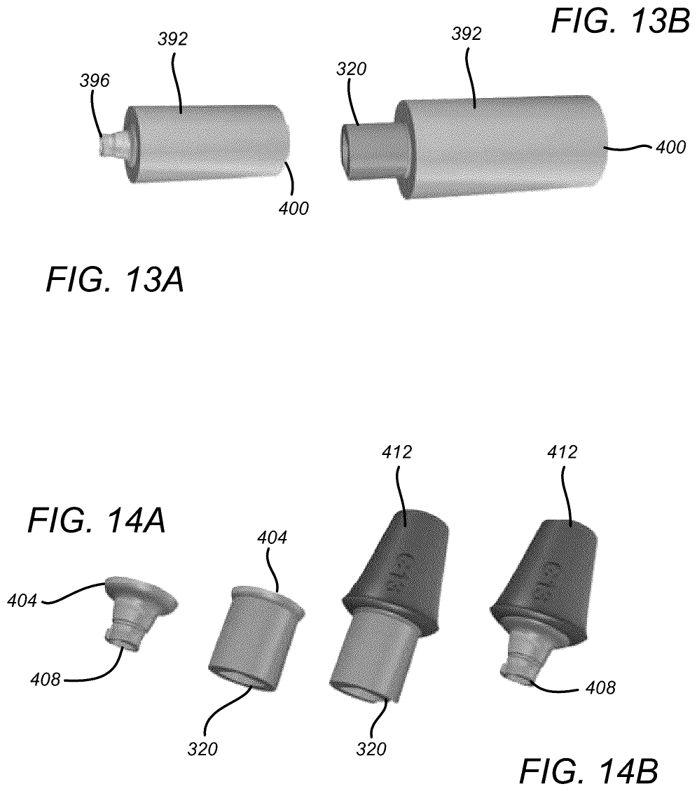

FIGS. 13A-13B illustrate an exemplary embodiment of titanium cylinders 392 for custom abutment laboratory milling machines. As shown in FIG. 13A, titanium cylinders 392 are generally prefabricated with an exposed implant connection 396 on one end of the cylinder 396 under DESS license. An opposite end 400 of the cylinder 396 is used to grab the cylinder in the milling machine. This popular approach is under strict scrutiny of regulatory agencies (i.e., the FDA) because the exposed implant connection 396 is at risk of being damaged in the harsh environment of the milling machine. However, as shown in FIG. 13B, with a protective cap 320, described in connection with FIGS. 11A-11B, placed onto the implant connection 396 the entire fabrication process of the abutment and prosthesis can be accomplished without any damage to the implant connection 396.

FIGS. 14A-14B illustrate a titanium base 404 that can be coupled with a protective cap 320, described with respect to FIGS. 11A-11B, for preparing a titanium abutment by way of titanium sintering printing. As is known, 3D printing of titanium powder is routinely done under EOS license (Germany). The printing process typically comprises preparing an aluminum plate with cavities wherein titanium abutment platforms are fixed in a position such that the top surface is flush with the surface of the plate. An advantage of this technique is that it is possible to 3D print several different abutments at once (for example, 150-200). The printing machine uses a rake to lay a thin layer of titanium powder on the entire aluminum plate. A laser sintering process melts the titanium powder onto the titanium base. The process of raking and sintering is repeated, adding layers of solid titanium to the abutment. When the printing process is completed, the loose powder is vacuumed.

Regulatory authorities are reluctant to accept titanium 3D printing for implant abutments because the titanium powder is known to be abrasive for the implant interface. However, as shown in FIG. 14A, an engaging end 408 of the titanium base 404 disposed within the protective cap 320, the entire fabrication process of the abutment and prosthesis can be accomplished without any damage to the interface. As shown in FIG. 14B, an abutment 412 can be printed onto the titanium base 404 while the engaging end 408 is protected by the protective cap 320. After the fabrication process is complete, the protective cap 320 can be removed to reveal the engaging end 408.

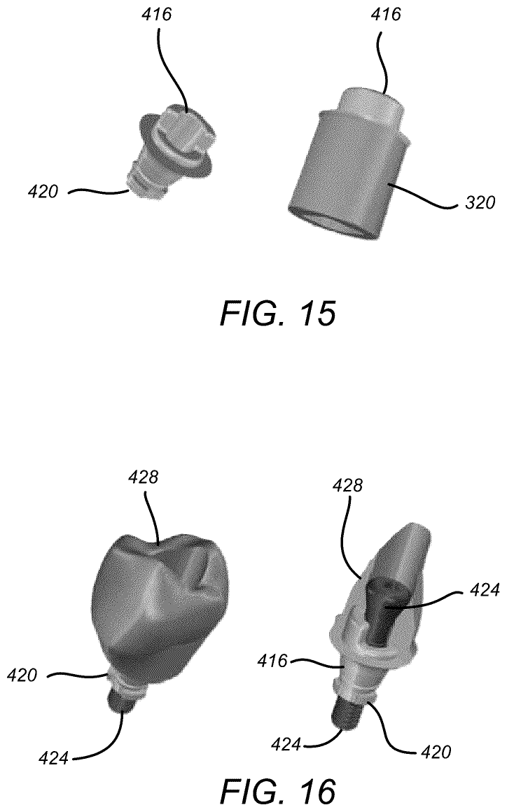

Moreover, it is contemplated that the protective cap 320 can be used to protect a base 416 during milling zirconia prosthesis. As shown in FIG. 15, while an engaging end 420 of the base 416 is be housed within the protective cap 320, the entire fabrication process of the abutment and the prosthesis can be accomplished without any damage to the engaging end 420 of the base 416.

Zirconia abutments or crowns typically are milled from a block of green state zirconia (e.g., soft state at 1.5 scale). The milled zirconia parts are sintered in an oven at a high temperature (typically 1350° C. to 1500° C.) to fuse the particles together, shrink the part to scale 1, and increase density and strength. Connections to the implants are assured by a titanium screw and a titanium interface that are bonded to the zirconia crowns or abutments. It is contemplated that this bonded connection is a weak link of the system. Thus, as shown in FIG. 16, a screw 424 can be used to clamp the titanium base 416 to zirconia crowns or abutments instead of relying on adhesive. In the embodiment of FIG. 16, the screw 424 clamps a fully milled zirconia prosthesis 428 to the titanium base 416. Further, in the illustrated embodiment, the titanium base 416 includes an engaging end 420 configured to engage with the dental implant 100. In some embodiments, however, the dental implant 100 is compatible with full zirconia abutments that are configured to rest on the implant flange 208 (see FIG. 3) and centered by the cylindrical portion 168 of the connection with or without engagement.

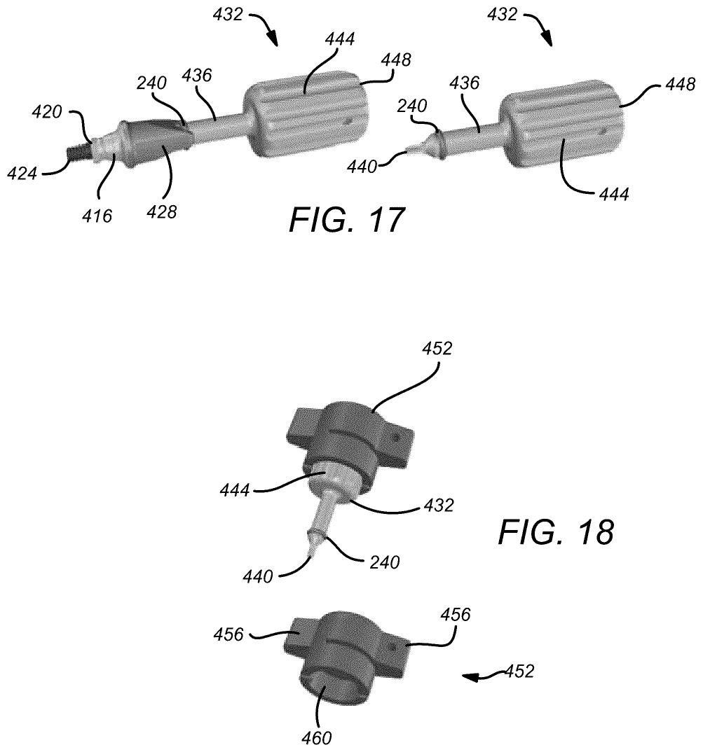

FIG. 17 illustrates an exemplary embodiment of a drop-preventing hand driver 432. As will be appreciated, dropping small implant components in the airways of a patient is an unacceptable risk. This complication is not addressed by the implant industry. As shown in FIG. 17, the drop-preventing hand driver 432 includes an O-ring 240 that is mounted to a shaft 436 of the hand driver 432. The O-ring 240 retains components on a distal end 440 of the hand driver 432 and thus enables safe transportation of the components from the tray to the patient's mouth. For example, as shown in FIG. 17, the O-ring 240 can be used to retain the titanium base 416 and milled zirconia prosthesis 428 engaged with the shaft 436 while the distal end 440 is used to thread the screw 424 into the dental implant 100. A multiplicity of grooves 444 are disposed around a proximal end 448 of the hand driver 432 to facilitate grasping and turning the hand driver 432.

FIG. 18 illustrates an exemplary embodiment of a disposable torque controller 452 configured to be coupled with the drop-preventing hand driver 432. The torque controller 452 comprises an injection molded handle with flexible wings 456 comprising thermoplastic polyurethane (TPU). The torque controller 452 includes an opening 460 that is configured to fit onto the proximal end 448 of the hand driver 432. Due to the grooves 444 in the hand driver 432, the flexible wings 456 are configured to bend at a precise torque of 35 Newton-cm (Ncm) in a clockwise direction. The grooves 444 of the hand driver 432 preferably are shaped such that they lock the flexible wings 456 in place when a counter-clockwise rotation is applied.

In general, surgical guides are used by those clinicians who want to achieve maximal precision in positioning of dental implants to master successful early delivery of provisional prosthesis, optimal esthetics, or significant anatomy avoidance. Traditional implants requiring predrilling have some limitations because the trajectory of the predrilling is always affected by the different bone densities encountered by the drill, inducing fractures or movements of the 3D printed guide. Consequently, the final position of the implant is not identical to the position planned in the treatment software. This phenomenon is observed for teeth, mucosa and bone supported surgical guides. In addition, traditional implant surgical guides do not offer any flexibility to the clinicians in terms of implant length and level of subgingival insertion.

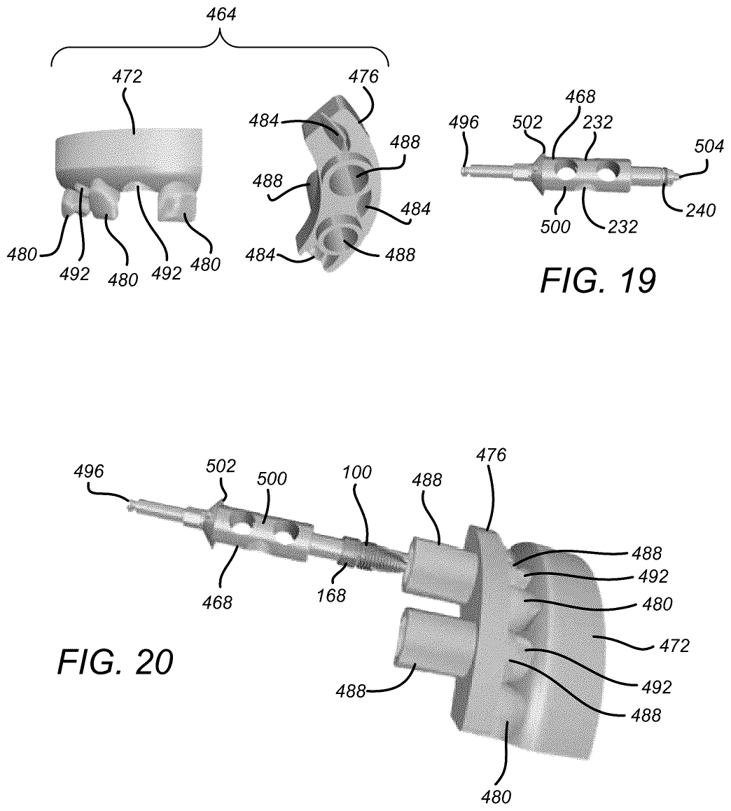

FIGS. 19-20 illustrate an exemplary embodiment of a stackable surgical guide 464 and an implant carrier 468 for achieving maximal precision in positioning of the dental implant 100. The stackable surgical guide 464 comprises a surgical guide 472 and a guide carrier 476 that are configured to cooperate with the implant carrier 468. In the illustrated embodiment, the surgical guide 472 includes uniquely shaped protrusions 480 that are configured to fit into shaped holes 484 disposed in the guide carrier 476. The shaped protrusions 480 and the shaped holes 484 are configured to ensure that the surgical guide 472 and the guide carrier 476 can be stacked in only one orientation that precisely aligns guide chimneys 488 of the guide carrier 476 with guide holes 492 disposed in the surgical guide 472, as shown in FIG. 20. The surgical guide 472 can be made of biocompatible 3D-printed resin and can fit teeth, mucosa or both and can be temporarily secured or not by orthopedic screws.

The guide carrier 476 is configured to deliver a neck of the dental implant 100 to the level of the bone crest regardless of the chosen implant length (when fully inserted). To achieve the landing of the implant tip in the intended spot, the guide chimneys 488 have a height that is calculated to engage the guided carrier 488 on about 3 mm for a 13-mm dental implant 100. Engagement for the 9-mm and 11-mm dental implants 100 are, respectively, about 7 mm and about 5 mm. The neck of the dental implant 100 will be placed 3 mm below the mucosal surface by default. In some embodiments, the depth of the neck of the dental implant 100 below the mucosal surface can be placed at a depth ranging between about 2 mm and about 6 mm. If the clinician wants to place the dental implant 100 below the bone crest, the dental implant 100 can be inserted further by using a standard implant carrier, having a 1-mm ruler on the shaft. Since the guide carrier 476 and the heights of the printed guide chimneys 488 are not implant length specific, the clinician can always make a last-minute change of the planned implant length, as well.

FIG. 19 further illustrates an exemplary embodiment of an implant carrier 468 configured to engage with the dental implant 100, as shown in FIG. 20. As will be recognized, the implant carrier 468 of FIG. 19 is similar to the implant carrier 216 shown in FIG. 5. The implant carrier 468 can be made of stainless steel and can be mounted in a standard mechanical dental contra-angle handpiece or a hand driver. The implant carrier 468 comprises three portions: a connector 496 for engaging with the hand piece, a shaft 500 having a depth-stop 502, and an engaging end 504. The shaft 500 can vary in length to accommodate clinical situations (e.g., long, medium, and short implant carriers). The depth-stop 502 is configured to touch the top of the guide chimneys 488 to limit the depth of implanting the dental implant 100. In some embodiments, the shaft 500 includes millimeter markings to provide guidance to the clinician on the sub-gingiva location of the implant neck.

The shaft 500 includes at least one hole 232 that aligns with the position of an engaging portion 236 (see FIG. 5) comprising the engaging end 504. The engaging end 504 is substantially identical to the engaging end 228 shown in FIG. 5. As such, the engaging portions 236 comprising the engaging end 504 are configured to fit between the engaging sections 204 of the dental implant 100. The hole 232 enables the clinician to orient one of the engaging portions 236 in a facial direction for fitting of gingival molds.

Moreover, as disclosed hereinabove, the engaging end 504 is configured to avoid touching the abovementioned conical portion of the cylindrical portion 168 when engaged with the dental implant 100 as shown in FIG. 20. An O-ring 240 disposed on the engaging tip 504 assures proper positioning of the implant carrier 468 into the dental implant 100 and prevents any implant drop between the implant package and the implantation site. Disengagement can be achieved by pulling the implant carrier 216 away from the dental implant 100.

While the apparatus and methods have been described in terms of particular variations and illustrative figures, those of ordinary skill in the art will recognize that the apparatus is not limited to the variations or figures described. In addition, where methods and steps described above indicate certain events occurring in certain order, those of ordinary skill in the art will recognize that the ordering of certain steps may be modified and that such modifications are in accordance with the variations of the apparatus. Additionally, certain of the steps may be performed concurrently in a parallel process, when possible, as well as performed sequentially as described above. To the extent there are variations of the apparatus, which are within the spirit of the disclosure or equivalent to the apparatus found in the claims, it is the intent that this patent will cover those variations as well. Therefore, the present disclosure is to be understood as not limited by the specific embodiments described herein, but only by scope of the appended claims.

What is claimed is:

1. A one-step dental implant for avoiding pressure points and heat production within a patient's bone, the dental implant comprising:
a bone cutting portion including a centering tip surrounded by bone cutting edges and soft tissue knives;
a deflecting side following each bone cutting edge;
a bone powder storage portion including one or more axial bone storage areas, each disposed between circular bone storage areas;
a bone thread cutter disposed along each trailing edge of the circular bone storage areas configured to have a taping effect on the bone;
a bone cortex interface including threads configured to engage with the bone and stabilize the dental implant;
a gingival sealing portion comprising a cylindrical portion for fitting into cortical bone without friction or exerting pressure on the bone; and
countersink reamers and microgrooves disposed around a circumference of the cylindrical portion.

2. The dental implant of claim 1, wherein the cylindrical portion includes an occlusal third surface comprising a polished metal surface that measures about 0.9 mm.

3. The dental implant of claim 2, wherein the cylindrical portion includes a conical connection includes a conical slope comprising a cervical section and an apical section.

4. The dental implant of claim 3, wherein conical slope comprises an angle ranging between about 25 degrees and 35 degrees; and wherein the angle is about 29 degrees.

5. The dental implant of claim 1, wherein the cylindrical portion comprises: a retention groove that removably retains components that include a silicone O-ring; one or more engaging sections comprising apical extensions of the cylindrical portion; a flange to provide a stop for temporary components and full zirconia abutments; and internal threads to enable clamping abutments onto the cylindrical portion.

6. The dental implant of claim 5, wherein the engaging sections enable driving the dental implant into the patient's bone and to prevent rotation of abutments when needed.

7. The dental implant of claim 1, wherein the soft tissue knives dissect the gingiva with a precise circular cut that has an internal diameter equal to a diameter of the dental implant within implant valleys between the threads comprising the bone cortex interface.

8. The dental implant of claim 7, wherein the soft tissue knives extend between about 0.2 mm and about 1.0 mm at the periphery to function as soft tissue dissector; and wherein the soft tissue knives extend by about 0.5 mm at the periphery.

9. The dental implant of claim 8, wherein the implant valleys have a diameter that creates a gap ranging between about 0.05 mm and about 0.2 mm to assist the axial bone storage areas in harvesting bone powder; and wherein the smaller diameter of the implant valleys is about 0.09 mm.

10. The dental implant of claim 1, wherein the bone cutting edges are configured to chisel the bone as the dental implant is tightened into the bone.

11. The dental implant of claim 1, wherein the deflecting sides provide spaces to receive bone chips and bone powder that can be directed into the bone powder storage portion without producing heat in the surrounding bone.

12. The dental implant of claim 1, wherein each of the deflecting sides has a section angle ranging between about 45 degrees and about 65 degrees in the center and an angle ranging between about 95 degrees and about 115 degrees with respect to flutes comprising the bone powder storage portion.

13. The dental implant of claim 1, wherein the three bone cutting edges meet at the center tip with any one or more of a point angle of about 67 degrees, a point length of about 0.9 mm, and a rake angle of about 77 degrees.

14. The dental implant of claim 13, wherein the point angle can range between about 50 degrees and about 80 degrees; wherein the point length can range between about 0.4 mm and about 1.5 mm; and wherein the rake angle can range between about 60 degrees and about 85 degrees.

15. The dental implant of claim 1, wherein the centering tip perforates the gingiva, contacts the bone, and then fixates a longitudinal axis of the dental implant within the bone.

16. The dental implant of claim 15, wherein the centering tip extends beyond the body of the dental implant by a distance ranging between roughly 0.2 mm and about 1.5 mm.

17. The dental implant of claim 1, wherein axial bone storage areas each has a pitch of about 50 mm and a width of about 2.25 mm with a depth of about 0.9 mm.

18. The dental implant of claim 17, wherein the pitch ranges between about 30 mm and about 70 mm; wherein the width ranges between about 1.5 mm and about 3.5 mm; and wherein the depth ranges between about 0.5 mm and about 1.5 mm.

19. The dental implant of claim 1, wherein the bone thread cutter has an angle ranging between about 50 degrees and about 85 degrees with respect to a wall of the axial bone storage area; and wherein the angle of the bone thread cutter is about 60 degrees.

20. The dental implant of claim 19, wherein the bone thread cutter has a progressively changing profile from a truncated triangle-shape to a full triangle-shape from the entry of the axial bone storage area to the end of the axial bone storage area.
